(19) United States
(12) Patent Application Publication
(10) Pub. No.: US 2003/0037379 A1
(43) Pub. Date: Feb. 27, 2003

(54) Inflatable cushion with built-in carrying case

(76) Inventors: Robert G Gibson, Newport Coast, CA (US); George D Heffner, Alvarado, TX (US); Terry E Lovett, Santa Ana, CA (US)

Correspondence Address: Albin H. Gess, Price and Gess, Suite 250, 2100 S.E. Main Street, Irvine, CA, 92614-6238, US

(21) Appl. No.: 09/934,203

(22) Filed: Aug. 21, 2001

(51) Int. Cl. B68G 5/00; A47C 16/00; A47C 20/02

(52) U.S. Cl. 5/655.3

(57) ABSTRACT

An inflatable cushion has a built-in carrying case. The carrying case is a zippered binder which lays flat when unzipped and serves as the bottom side of the inflated cushion. The cushion contains at least one baffle to stabilize and support the inflated cushion. The binder is covered in a rugged material. The cushion collapses into the interior space of the zippered binder for transport or storage between uses.

### BACKGROUND OF THE INVENTION

1. Field of the Invention

The present invention relates generally to improvements in cushions and more particularly pertains to new and improved collapsible cushions.

2. Description of the Prior Art

There are a large variety of cushions in the prior art used for footrests, headrests, and leg rests, for example. The cushions used for footrests are essentially footstools for supporting and resting the feet of people. Some of these footrests are inflatable and deflatable for ease of transport and storage. These prior art cushions and footrests may all be suitable for the particular purpose which they address. However, they do not provide the collapsibility and ease of transport and storage of the present invention.

### SUMMARY OF THE INVENTION

An inflatable cushion has a base made out of an abrasive-resistant material formed to fold at its middle into a book-like shape. A fastener mechanism around the perimeter of the base encloses three sides of the base when folded. An inflatable bladder attached to the base has a valve for allowing inflation and deflation of the bladder. The bladder is baffled to provide a stable cushion for supporting weight when inflated. The bladder is fully contained inside the base when deflated and the base is folded and fastened around its three sides, creating a compact, easily transportable or storable package.

### BRIEF DESCRIPTION OF THE DRAWINGS

The objects and many of the attendant advantages of this invention will become readily apparent upon consideration of the following detailed description in conjunction with the accompanying drawings in which like reference numerals designate like parts throughout the figures thereof and wherein:

FIG. 1 is a perspective view of a preferred embodiment of the invention in its compact transportable state;

FIG. 2 is a plan view of one side of the embodiment of FIG. 1;

FIG. 3 is a plan view of one end of the embodiment of FIG. 2;

FIG. 4 is a plan view of the other end of the embodiment of FIG. 2;

FIG. 5 is a perspective view of a preferred embodiment of the invention in an open state; and

FIG. 6 is a perspective view, partially cut-away to show the interior, in its expanded state of a preferred embodiment of the invention.

### DETAILED DESCRIPTION OF THE PREFERRED EMBODIMENTS

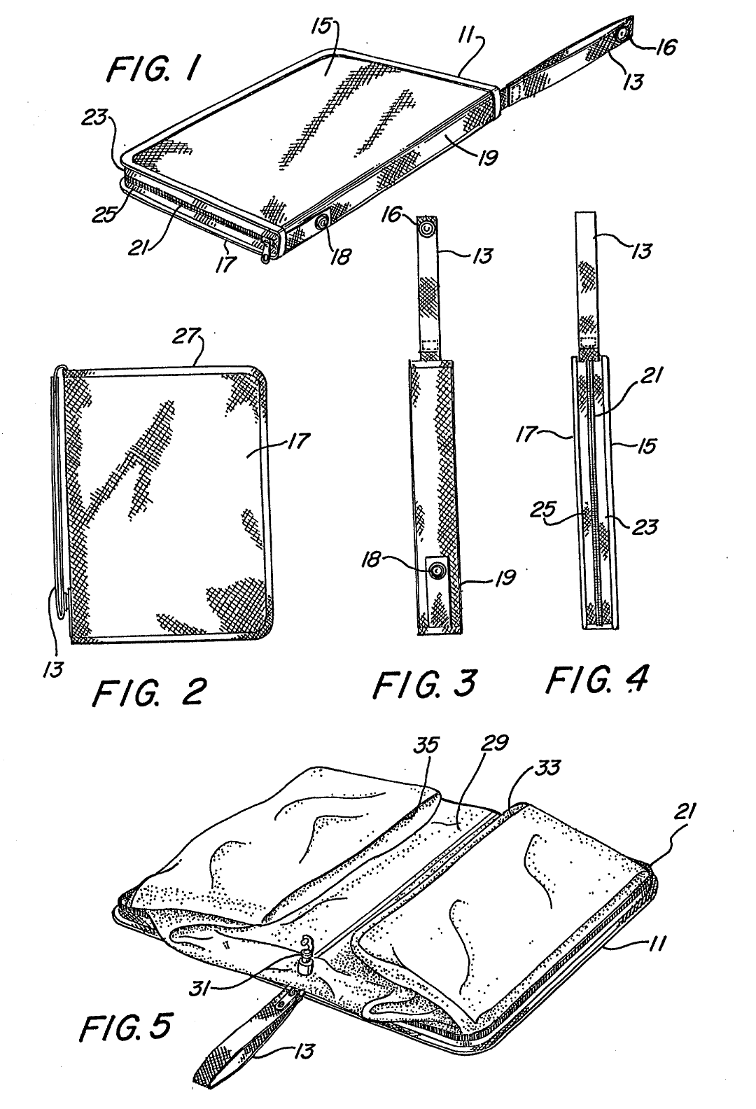

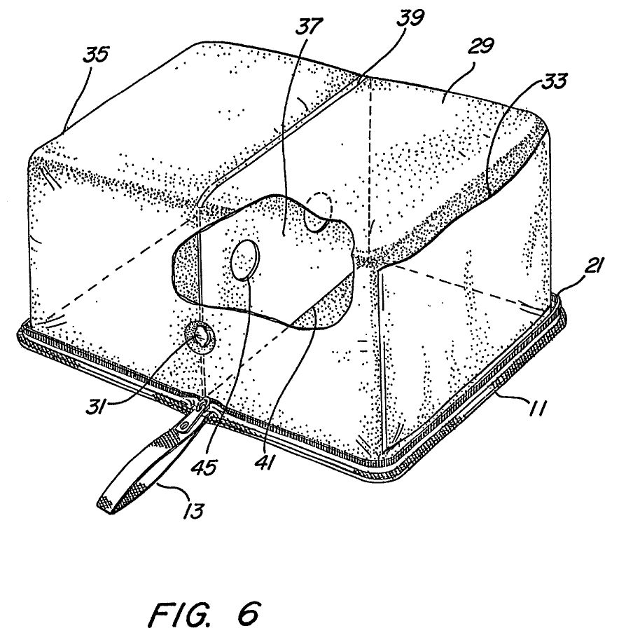

FIGS. 1-4 illustrate the inflatable cushion with built-in carrying case 11 of the present invention closed up, for transport or storage. In this closed up state, the footrest 11 looks like a book binder having two sides 15 and 17 and a back 19. The space between the sides 15 and 17 around the perimeter of the sides 15 and 17, from the bottom of back 19 to the top of back 19, is taken up by a fastener, such as a Velcro strip, snap strip, or zipper 21 and its associated attachment cloth 23, 25 or any equivalent thereof.

In order to utilize the cushion 11, zipper 21 is unzipped so that the sides 15 and 17 can be folded flat as shown in FIG. 5, exposing the bladder 29 which has one of its sides attached by glue, sewing, or heat sealing, or any equivalent thereof, to the inside surface of sides 15 and 17. Bladder 29 has a valve 31 which allows the bladder to be inflated by mouth. Once the bladder 29 is inflated, as shown in FIG. 6, the valve may be closed off and stored in the interior of the bladder 29. The cushion 11 is then set up for use.

At least one baffle 37 on the inside of the bladder 29 helps maintain the cushion's shape. The baffle 37 is sealed to the inside of the bladder 29 along its edges 43, 41, 39. A series of apertures 45 in the baffle allow air to pass from one side to the other. The sides of the cushion preferably have pouches 33 and 35 for insertion of a magazine, water bottle or other useful article, as desired by the user of the cushion.

These cushions are specifically suitable for use by travelers on trains and airplanes, or whenever sitting for long periods of time is required and elevation of the feet provides relief to the user.

After use, the bladder 29 is deflated through valve 31, folded as shown in FIG. 5 and the sides zipped up into its convenient book binder shape, (FIG. 1).

A strap 13 attached to the back 19 is designed to slip easily over the wrist of the user for carrying purposes. The strap 13 is easily converted into a handle for carrying the cushion 11 by attaching the end of strap 13 having a male snap 16 to the back 19 of the cushion at the female snap 18.

What is claimed is:

1. An inflatable cushion, comprising:
a base having a perimeter formed to fold at its middle;
a fastener attached to the perimeter of the base;
an inflatable bladder having a bottom attached to said base; and
a valve in said bladder for allowing air into and out of the bladder.

2. The cushion of claim 1 wherein said base is made of tear resistant and abrasive resistant material.

3. The cushion of claim 1 wherein said base folds at its middle into a book-like shape.

4. The cushion of claim 1 further comprising a carrying strap attached to said base.

5. The cushion of claim 1 wherein the fastener encloses three sides of the base when it is folded at its middle.

6. The cushion of claim S wherein the middle of the base has a dimension that is about the thickness of the base when it is folded and fastened.

7. The cushion of claim 1 wherein the base is rectangular in shape.

8. The cushion of claim 7 wherein the bladder inflates into a rectangular solid with a top surface parallel to the base.

9. The cushion of claim 1 wherein the valve is designed for allowing inflation of the bladder by mouth.

10. The cushion of claim 1 wherein the bladder comprises a pouch at a side for holding magazines and the like.

11. The cushion of claim 1 wherein the middle of the base has a dimension that is about the thickness of the base when it is folded and fastened with the bladder inside.

12. The cushion of claim 11 wherein said base is made of tear resistant and abrasive material.

13. The cushion of claim 12 further comprising a carrying strap attached to said base.

14. The cushion of claim 11 further comprising a carrying strap attached to said base.

15. The cushion of claim 14 wherein the base is rectangular in shape.

16. The cushion of claim 15 wherein the bladder inflates into a rectangular solid with a top surface parallel to the base.

17. The cushion of claim 16 wherein the valve is designed for allowing inflation of the bladder by mouth.

18. The cushion of claim 17 wherein the bladder comprises a pouch at a side for holding magazines and the like.

19. The cushion of claim 1 wherein the fastener is a zipper.

20. The cushion of claim 1 wherein said bladder includes a baffle inside the bladder.
